(19) United States
(12) Patent Application Publication
(10) Pub. No.: US 2016/0261707 A1
(43) Pub. Date: Sep. 8, 2016

(54) SIGN-UP AND PROVISIONING IN ONLINE REPUTATION MANAGEMENT WITH REPUTATION SHAPING

(71) Applicant: MICROSOFT TECHNOLOGY LICENSING, LLC, Redmond, WA (US)

(72) Inventors: Rajmohan Rajagopalan, Sammamish, WA (US); Michael Stokes, Redmond, WA (US); Carolyn Sparling, Lynnwood, WA (US)

(21) Appl. No.: 14/723,836

(22) Filed: May 28, 2015

Related U.S. Application Data
(60) Provisional application No. 62/129,600, filed on Mar. 6, 2015.

(51) Int. Cl. H04L 29/08

(52) U.S. Cl. CPC H04L 67/306; G06Q 50/01

(57) ABSTRACT

Sign-up and provisioning in online reputation management with reputation shaping are provided. A service such as a reputation management service authenticates a reputation manager to allow the reputation manager to configure a reputation profile to shape the online reputation associated with a reputation owner. Digital assets associated with the reputation and hosted by external resources are discovered. The digital assets and the reputation profile are analyzed to match suggested actions with operations to shape the online reputation. The digital assets, the reputation profile, and the suggested actions are transmitted to the reputation manager to prompt the reputation manager to customize the reputation profile and the suggested actions to shape the online reputation.

### CROSS-REFERENCE TO RELATED APPLICATION

This application claims priority under 35 U.S.C. §119(e) to U.S. Provisional Patent Application Ser. No. 62/129,600 filed on Mar. 6, 2015. The disclosure of the U.S. Provisional Patent Application is hereby incorporated by reference in its entirety.

### BACKGROUND

The proliferation of computerized automation of processes in every aspect of life, data storage and processing have become a major component of networked systems handling social interactions. In such systems, social data is entered, modified, or deleted from a number of sources. Various social data stores from simple tables to complicated databases are maintained and synchronized as new entries or modifications are made by different sources. In addition, variety of services are offered to enable internal and external parties' interactivity with the social data hosted by the data stores. Continued maintenance of a reputation of an online subscriber present significant challenges in management and disposition of the social data.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to sign-up and provisioning in online reputation management with reputation shaping. In some example embodiments, a reputation management service may authenticate a reputation manager to allow the reputation manager to configure a reputation profile to shape the online reputation associated with a reputation owner. Digital assets associated with the reputation and hosted by external resources may be discovered. The digital assets and the reputation profile may be analyzed to match suggested actions with operations to shape the online reputation. The digital assets, the reputation profile, and the suggested actions may be transmitted to the reputation manager to prompt the reputation manager to customize the reputation profile and the suggested actions to shape the online reputation.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of sign-up and provisioning in online reputation management with reputation shaping, according to embodiments;

FIG. 2 illustrates an example of interactions between a reputation management service and an external resource to provide sign-up and provisioning in online reputation management with reputation shaping, according to embodiments;

FIG. 3 illustrates a component diagram of a reputation management service that provides sign-up and provisioning in online reputation management with reputation shaping, according to embodiments;

FIG. 4 illustrates an example of a user interface to provide sign-up and provisioning in online reputation management with reputation shaping, according to embodiments;

FIG. 5 is a simplified networked environment, where a system according to embodiments may be implemented;

FIG. 6 illustrates a general purpose computing device, which may be configured to sign-up and provisioning in online reputation management with reputation shaping, according to embodiments; and

FIG. 7 illustrates a logic flow diagram for a process to provide sign-up and provisioning in online reputation management with reputation shaping, according to embodiments.

### DETAILED DESCRIPTION

As briefly described above, sign-up and provisioning in online reputation management with reputation shaping may be provided by a reputation management service. The reputation management service may authenticate a reputation manager to allow the reputation to configure a reputation profile to shape the line reputation associated with a reputation owner. The reputation manager may include the reputation owner, a legal representative of the reputation owner, an authorized family member of the reputation owner, an authorized relation of the reputation owner, an authorized colleague of the reputation owner, or an authorized supervisor of the reputation owner, among other authorized relations of the reputation owner.

The reputation management service may discover digital assets associated with the reputation owner. The digital asset may be hosted by external resources. Furthermore, the digital assets may be owned by the reputation owner. Alternatively, the digital asset may include third party content that identify the reputation owner.

The reputation management service may analyze the digital assets and the reputation profile to match suggested actions. The suggested actions may include operations to shape the online profile of the profile owner. The suggested actions may remove, add, and modify associations between the profile owner and the digital assets. The digital assets, the reputation profile, and the suggested actions may be transmitted to the reputation manager to prompt the reputation manager to customize the reputation profile and the suggested actions to shape the online reputation.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to provide sign-up and provisioning in online reputation management with reputation shaping. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience —a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

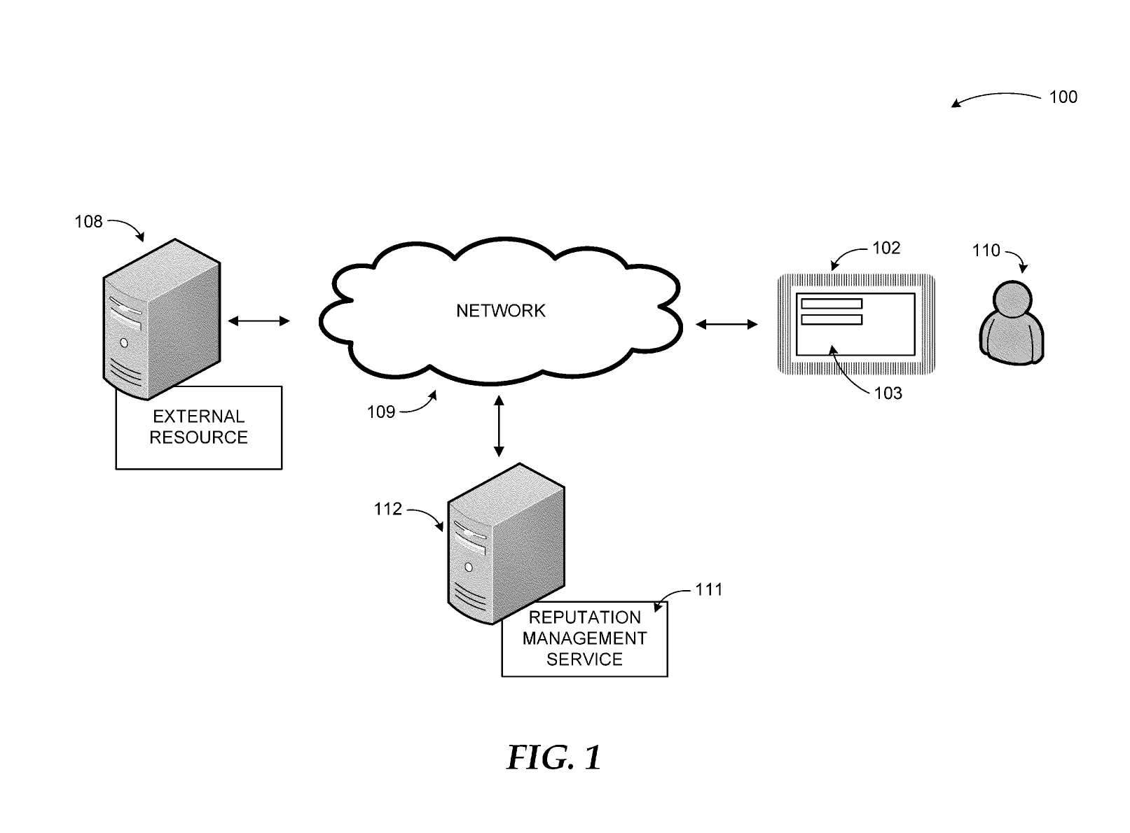

FIG. 1 is a conceptual diagram illustrating an example of sign-up and provisioning in online reputation management with reputation shaping, according to embodiments.

In a diagram 100, a computing device 112 may execute a reputation management service 111. An example of the reputation management service 111 may include an application that provides information and data processing functionality. The computing device 112 may include a hardware based server, a laptop computer, and a desktop computer, among others.

The computing device 112 may communicate with an external resource 108 and a client device 102 through a network 109. The external resource 108 may host digital assets associated with a reputation owner. An aggregation of digital assets associated with the reputation owner hosted by various external resources may form an online reputation of the reputation owner.

The external resource 108 may provide a variety of productivity services. Examples of a productivity service may include a communication service, a social networking service, a professional networking service, an application service, and a storage service, among others. The communication service may facilitate communication between callers. The storage service may host digital assets associated with reputation owners. The application service may provide applications for use and consumption by client devices.

The network 109 may include wired and wireless components that allow wired and wireless communication between nodes such as the external resource 108, the computing device 112, and the client device 102, among others. The client device 102 may display a client user interface (UI) 103 of the reputation management service 111 to a reputation manager 110. The client UI 103 may provide functionality to provide sign-up and provisioning in online reputation management with reputation shaping by allowing the reputation manager 110 to customize digital assets, reputation profile, and suggested actions with operations to shape the online reputation, among others.

The reputation management service 111 may authenticate the reputation manager 110 to allow the reputation manager 110 to configure a reputation profile. The reputation profile may be used to shape the online reputation associated with a reputation owner. A search may be executed with identification information of the reputation owner (stored within the reputation profile) to discover digital assets hosted by external resource 108. The digital assets and the reputation profile may be analyzed to match to suggested actions to shape the online reputation. The digital assets, the reputation profile, and the suggested actions may be transmitted to the reputation manager 110 to prompt the reputation manager 110 to customize the reputation profile and the suggested actions to shape the online reputation.

The reputation manager 110 may be allowed to interact with the client UI 103 through an input device or touch enabled display component of the client device 102. The client device 102 may include a display device such as the touch enabled display component, and a monitor, among others. The display device may be used to provide the client UI 103 of the reputation management service 111 to the reputation manager 110.

The reputation manager 110 may interact with the client UI 103 with a keyboard based input, a mouse based input, a voice based input, a pen based input, and a gesture based input, among others. The gesture based input may include one or more touch based actions such as a touch action, a swipe action, and a combination of each, among others.

Digital assets such as pictures, documents, accounts, account information (such as account status information), among others hosted by the external resource 108 may be discovered as part of the online reputation of the reputation owner. The digital assets and a reputation profile may be matched to suggested actions to shape the online reputation of the reputation owner. The digital assets, the reputation profile, and the suggested actions may be displayed to the reputation manager 110 on the client UI 103 of the reputation management service to prompt the reputation manager 110 to customize the reputation profile and the suggested actions.

While the example system in FIG. 1 has been described with specific components including the computing device 112, the reputation management service 111, embodiments are not limited to these components or system configurations and can be implemented with other system configuration employing fewer or additional components.

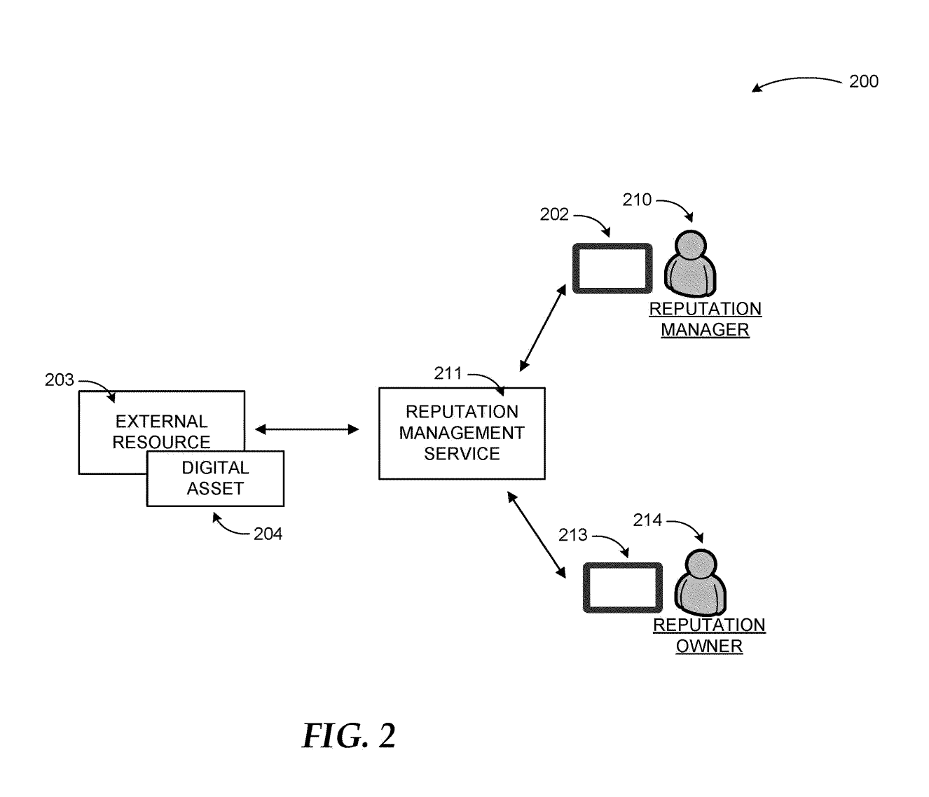

FIG. 2 illustrates an example of interactions between a reputation management service and an external resource to provide sign-up and provisioning in online reputation management with reputation shaping, according to embodiments.

In a diagram 200, a reputation management service 211 may interact with an external resource 203 to provide sign-up and provisioning in online reputation management with reputation shaping. Digital assets associated with a reputation owner hosted across various external resources may form an online reputation of the reputation owner. A digital asset 204 may include a document, an account, among others associated with a reputation owner 214. The digital asset 204 may be owned by the reputation owner 214. Alternatively, the digital asset 204 may be a third party content owned by a third party. The third party content may identify the reputation owner 214.

The reputation management service 211 may authenticate the reputation manager 210 through a client UI of the reputation management service 211 displayed on a client device 202. The reputation manager 210 may configure a reputation profile of the reputation owner 214. The reputation profile may include one or more reputation goals such as a request to remove negative publications associated with the reputation owner 214.

Credentials to an account of the reputation owner 214 may also be captured within the reputation profile. The reputation owner 214 may provide the credentials to a client UI of the reputation management service 211 displayed on a client device 213. The reputation manager 210 may be authorized to use the credentials to build the reputation profile. The reputation manager 210 may be authorized to view the credentials. Alternatively, the credentials of the reputation owner 214 may be hidden from the reputation manager 210 while allowing use of the credentials to build the reputation profile.

The reputation manager 210 may include the reputation owner 214, a legal representative of the reputation owner 214, an authorized family member of the reputation owner 214, an authorized relation of the reputation owner 214, an authorized colleague of the reputation owner 214, and an authorized supervisor of the reputation owner 214, among others. The reputation manager 210 may also be authorized to build a reputation profile for a legal relationship of the reputation owner 214. In an example scenario, a reputation manager 210 such as a parent may be allowed to build a reputation profile of a reputation owner such as a child. In another example scenario, the reputation manager 210 may include a supervisor of an employee identified as the reputation owner 214.

In response to an identification of the reputation manager 210 as a legal relationship of the reputation owner 214, the reputation management service 211 may request a legal documentation from the reputation manager 210 to prove the legal relationship. After receiving the legal documentation, the reputation manager 210 may be authenticated to allow a configuration of the reputation profile of the reputation owner 214.

In response to a detection of a failure to provide the legal documentation within a period of time, the reputation manager 210 may be declined for authentication. The authentication may be declined to prevent a configuration of the reputation profile by the reputation owner 210. The period of time may be defined by the reputation owner 214 or by a default system setting.

The reputation manager 210 may also be authenticated using heightened levels of authentication to prevent an authentication of a wrong person from accessing and altering private information associated with the reputation owner 214. A biometrics scheme may be used to confirm an identity of the reputation manager 210. Alternatively, or in addition to the biometrics scheme, a heuristics scheme may be used to confirm an identity of the reputation manager 210. The heuristics scheme may verify the identity of the reputation manager 210 based on a recent activity, or a past action on the digital assets, among other actions as performed by the reputation owner.

The reputation management service 211 may also subject the reputation manager 210 to a time limit to build the reputation profile. A timeout strategy may restrict a number of changes to the online reputation as requested by the reputation owner 214 through the reputation profile. Alternatively, the reputation management service 211 may restrict a number of accesses to a session to build the reputation profile. Access restrictions may force the reputation manager 210 to seek additional authorization from the reputation owner 214 to allow additional changes to the online profile of the reputation owner 214. The reputation owner 214 may transmit an extended authorization to the reputation management service 211 to allow the reputation manager 210 to continue to build the reputation profile.

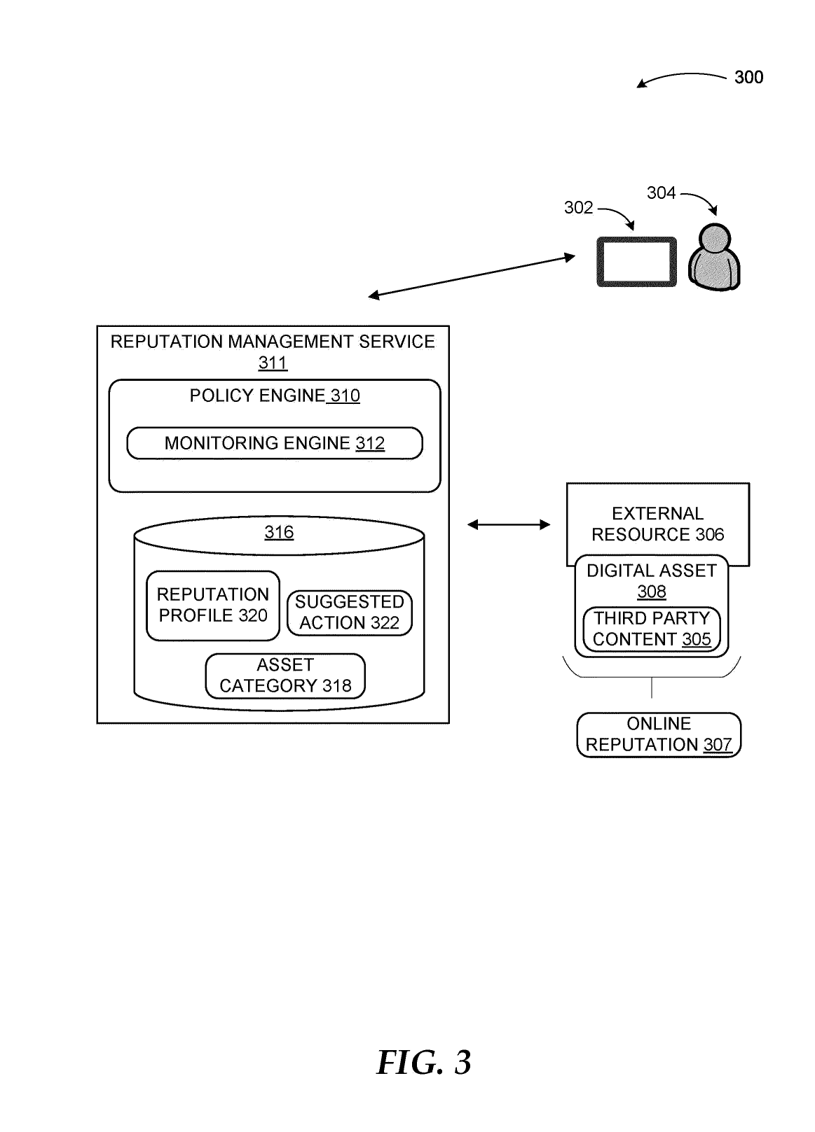

FIG. 3 illustrates a component diagram of a reputation management service that provides sign-up and provisioning in online reputation management with reputation shaping, according to embodiments.

In a diagram 300, a reputation management service 311 may interact with a reputation manager 304 through a client UI of the reputation management service 311 displayed on a client device 302. The reputation management service 311 may discover a digital asset 308 with a reputation profile 320 configured by the reputation manager 304. The reputation profile 320 may identify a reputation goal and credentials of a reputation owner to shape the online reputation of the reputation owner. The reputation owner (or the reputation manager 304) may provide the credentials to accounts on the external resource 306 that host the digital asset 308.

The digital asset 308 may be owned by the reputation owner. Alternatively, the digital asset 308 may include a third party content 305 owned by a third party. The third party content 305 may identify the reputation owner. The digital asset 308 owned by the reputation owner or by a third party and other digital assets may form the online reputation 307 of the reputation owner. The reputation goal identified in the reputation profile 320 may provide action descriptions to shape the online reputation of the reputation owner.

The reputation profile 320, the digital asset 308 may be matched to suggested actions. In an example scenario, a profile goal of “remove negative comments” within the reputation profile may be matched to a suggested action 322. The suggested action 322 may include operation to remove the digital asset 308 that may describe “negative comments” posted by the reputation owner. In another example scenario, a profile goal of “improve visibility” may be matched to the suggested action 322. The suggested action 322 may include operations to post the digital asset 308 to other external resources where the reputation owner may have accounts.

In another example scenario, a profile goal of “disassociate from content of a third party” may be matched to the suggested action 322. The suggested action 322 may include a disassociation request to transmit to the external resource 306. The disassociation request may include instructions to disassociate an identification information that identifies the reputation owner in the third party content 305.

The reputation profile 320 and the digital asset 308 may be matched to the suggested action 322 by a policy engine 310 of the reputation management service 311. The policy engine may 310 may match the attributes of the reputation profile 320 and the digital asset 308 to a subset of default reputation shaping actions. The subset of the default reputation shaping actions may be selected as suggested actions (such as the suggested action 322). The suggested action 322 may include operations to modify, add to, and remove the digital asset 308 to shape the online reputation of the reputation owner.

A monitoring engine 312 may be used to monitor and to discover the digital asset 308 and the third party content 305 to detect changes. Changes may be used to update the suggested action 322 based on attributes of the changes. An example of a change may include a new identification of the reputation owner in the third party content 305. The digital asset 308 may be re-analyzed to match the change to the suggested action 322. The suggested action 322 may be updated to shape the online reputation of the reputation owner based on instructions from the reputation manager.

The monitoring engine 312 may be a component of the policy engine 310. Alternatively, the monitoring engine 312 may be a stand-alone component of the reputation management service 311. The monitoring engine 312 may also be used to discover usage information associated with the reputation owner and the external resource 306. The usage information may be identified as the digital asset 308. The suggested action 322 may be matched to shape the online reputation of the reputation owner to manage the usage data.

The reputation profile 320, the suggested action 322, and an asset category may be stored in a data store 316. The asset category 318 may be used to classify the digital asset 308. The asset category 318 may be used to focus match operations performed on the suggested action 322 and the digital asset 308. In an example scenario, the suggested actions may be partitioned by asset categories. The digital asset 308 may be classified in the asset category 318. The suggested action 322 that matches the asset category 318 may also be matched to the digital asset 308.

The asset category 318 may include a private classification, a work-related classification, a sensitive classification, a secret classification, a time of creation based classification, a location of creation based classification, a creator based classification, or a modifier based classification, among others. The asset category 318 may also include a picture classification, a document classification, a music classification, a video classification, a purchased subscription classification, a social networking account association, or a professional networking account association, among others.

The digital asset 308, the reputation profile 320, the suggested action 322, and asset category 318 may be transmitted to the reputation manager 304 to prompt the reputation manager to customize the reputation profile 320, asset category 318 and the suggested action 322 and confirm a selection of the digital asset 308. In response to a confirmation of the reputation profile 320, the asset category 318, the suggested action 322, and a selection of the digital asset 308, the suggested action 322 may be executed to perform operations to shape the online reputation of the reputation owner.

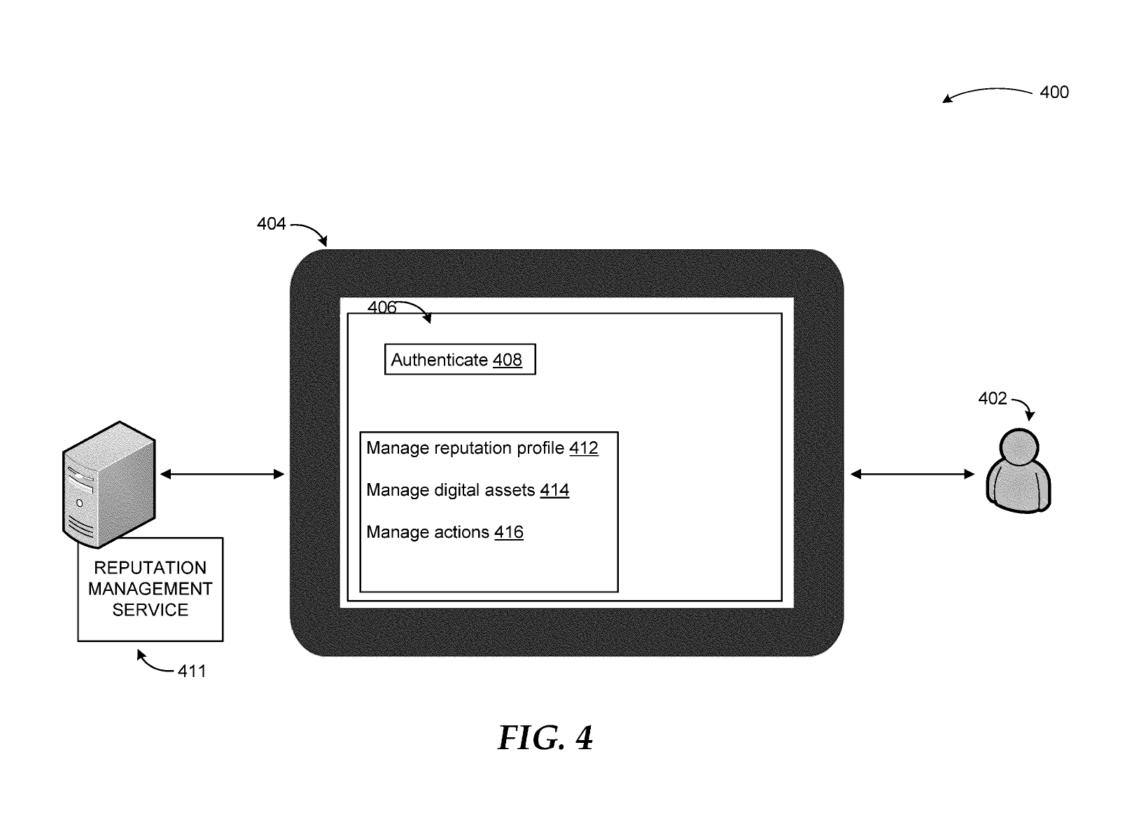

FIG. 4 illustrates an example of a user interface to provide sign-up and provisioning in online reputation management with reputation shaping, according to embodiments.

In a diagram 400, a reputation management service 411 may provide a client UI 406 on a computing device 404 to allow a reputation manager 402 to review and verify a suggested action, a selection of a digital asset, a reputation profile, and an asset category to shape an online reputation of a reputation owner.

The client UI 406 may display an “authenticate” control 408. In response to an activation of the “authenticate” control 408, the client UI may display additional controls to capture credentials of the reputation manager 402. The client UI 406 may also display additional controls to authenticate the reputation manager 402 through heightened levels of authentication such as biometrics authentication, among others.

The client UI 406 may display a “manage reputation profile” control 412 to provide the reputation manager 402 with additional controls to modify a reputation profile of the reputation owner. The reputation manager 402 may be provided with the additional controls to modify a reputation goal and credentials associated with accounts of the reputation owner that host the digital assets.

The client UI 406 may display a “manage digital assets” control 414 to provide the reputation manager 402 with additional controls to modify a list of digital assets associated with the reputation owner. The reputation manager 402 may be provided with the additional controls to select a subset of the digital assets to shape an online reputation of a reputation owner.

The client UI 406 may display a “manage actions” control 416 (upon activation) to provide additional controls to select and modify suggested actions that include operations to shape online reputation of the reputation owner. An example may include a list of suggested actions such as an add to action, a delete action, or a modify action, among others. The reputation manager 402 may be provided with controls to select and modify the suggested actions from the list.

According to embodiments described herein, the technical advantage of sign-up and provisioning in online reputation management with reputation shaping may include improved usability of online reputation with optimized actions generated to provide sign-up and provisioning in online reputation management with reputation shaping. A reputation profile and optimized actions to shape an online reputation may address a need that arises from extensive digital personalities generated by reputation owners in an extensive digital world. The reputation profile and the optimized actions may streamline shaping of an online reputation compared to cumbersome legacy manual reputation review solutions.

Embodiments address a need that arises from very large scale of operations created by networked computing and cloud based services that cannot be managed by humans. The actions/operations described herein are not a mere use of a computer, but address results of a system that is a direct consequence of software used as a service such as reputation management services offered in conjunction with shaping of an online reputation of a reputation owner.

The example scenarios and schemas in FIG. 1 through 4 are shown with specific components, data types, and configurations. Embodiments are not limited to systems according to these example configurations. Sign-up and provisioning in online reputation management with reputation shaping may be implemented in configurations employing fewer or additional components in applications and user interfaces. Furthermore, the example schema and components shown in FIG. 1 through 4 and their subcomponents may be implemented in a similar manner with other values using the principles described herein.

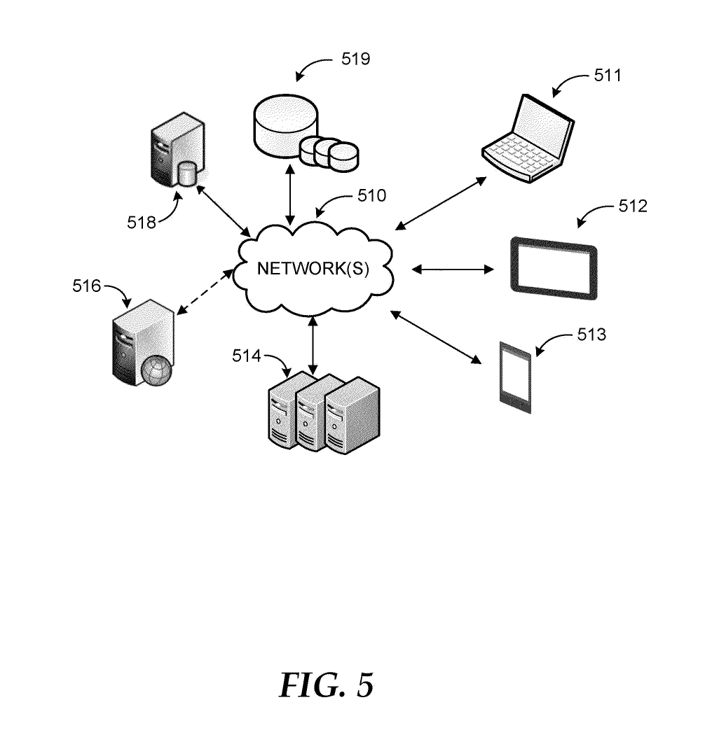

FIG. 5 is an example networked environment, where embodiments may be implemented. A reputation management service configured to sign-up and provisioning in online reputation management with reputation shaping may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A reputation management service may authenticate a reputation manager to allow the reputation manager to configure a reputation profile to shape the online reputation associated with a reputation owner. Digital assets associated with the reputation and hosted by external resources may be discovered. The digital assets and the reputation profile may be analyzed to match suggested actions with operations to shape the online reputation. The digital assets, the reputation profile, and the suggested actions may be transmitted to the reputation manager to prompt the reputation manager to customize the reputation profile and the suggested actions to shape the online reputation. The reputation management service may store data associated with digital asset in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide sign-up and provisioning in online reputation management with reputation shaping. Furthermore, the networked environments discussed in FIG. 5 are for illustration purposes only. Embodiments are not limited to the example applications, modules, or processes.

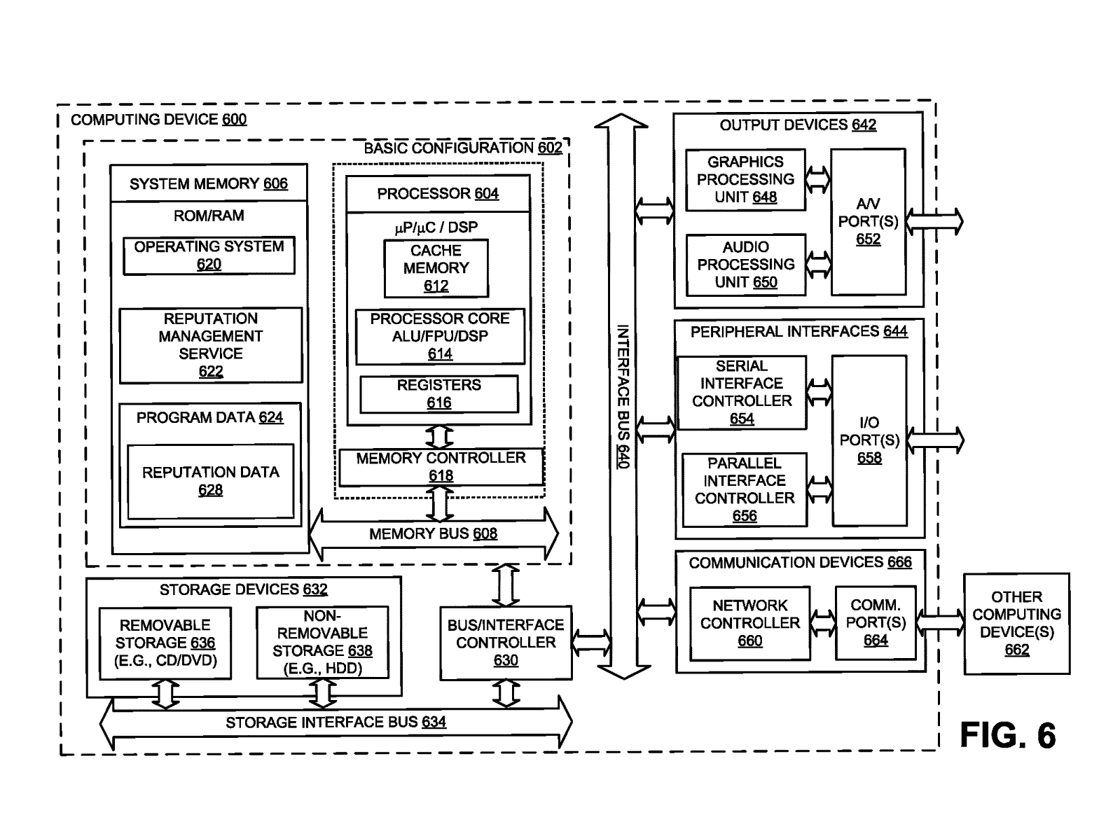

FIG. 6 illustrates a general purpose computing device, which may be configured to provide sign-up and provisioning in online reputation management with reputation shaping, arranged in accordance with at least some embodiments described herein.

For example, the computing device 600 may be used to provide sign-up and provisioning in online reputation management with reputation shaping. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a reputation management service 622, and a program data 624. The reputation management service 622 may authenticate a reputation manager to allow the reputation manager to configure a reputation profile to shape the online reputation associated with a reputation owner. Digital assets associated with the reputation and hosted by external resources may be discovered. The digital assets and the reputation profile may be analyzed to match suggested actions with operations to shape the online reputation. The digital assets, the reputation profile, and the suggested actions may be transmitted to the reputation manager to prompt the reputation manager to customize the reputation profile and the suggested actions to shape the online reputation. Components of the reputation management service 622 (such as a client user interface) may also be displayed on a display device. An example of the display device may include another computing device with a display component. The display device may include a touch based device that detects gestures such as a touch action. The display device may also provide feedback in response to detected gestures (or any other form of input) by transforming a client user interface of the reputation management service 622, displayed by the touch based device. The program data 624 may also include, among other data, reputation data 628, or the like, as described herein. The reputation data 628 may include a reputation profile, a digital asset, a suggested action, an asset category, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide sign-up and provisioning in online reputation management with reputation shaping. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

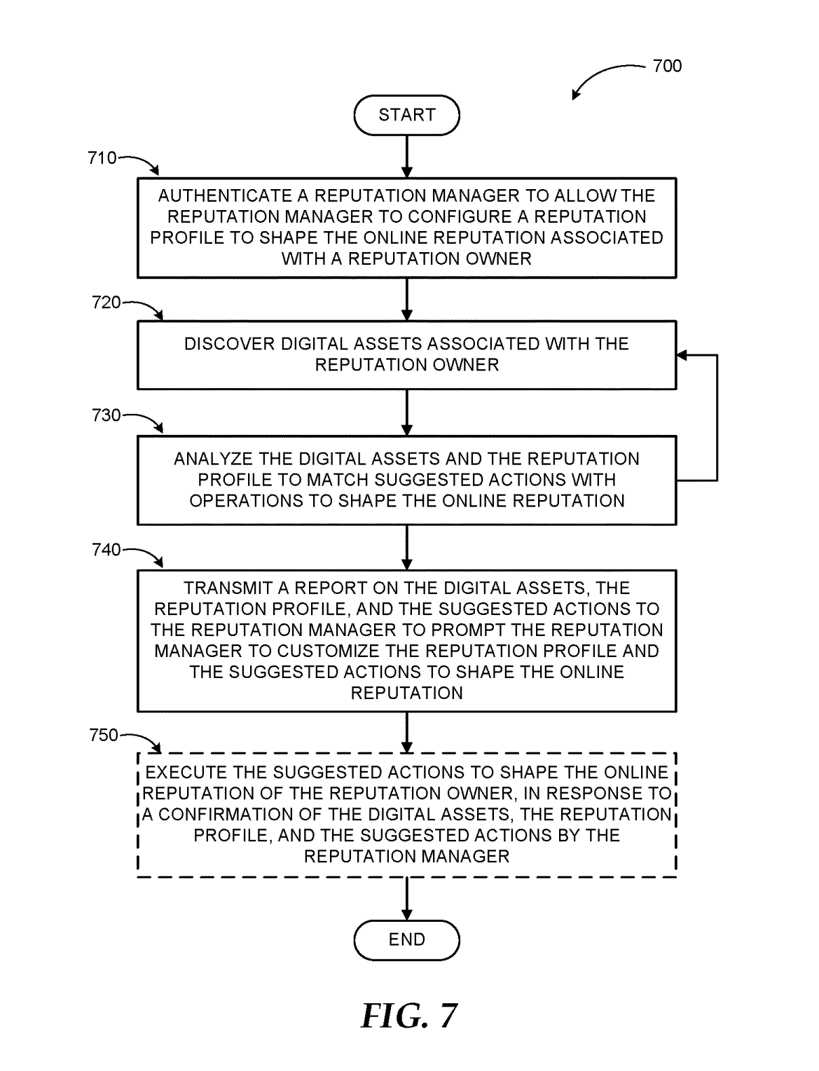

FIG. 7 illustrates a logic flow diagram for a process to provide sign-up and provisioning in online reputation management with reputation shaping, according to embodiments. Process 700 may be implemented on a reputation management service.

Process 700 begins with operation 710, where a reputation manager may be authenticated to allow the reputation manager to configure a reputation profile to shape the online reputation associated with a reputation owner. The reputation profile may include a reputation goal and credentials of accounts hosted at the external resource. At operation 720, digital assets associated with the reputation owner may be discovered. The digital assets may be hosted by the external services and form the reputation profile. The credentials in the reputation profile may be used to access the accounts that store the digital assets.

The digital assets and the reputation profile may be analyzed to match suggested actions with operations to shape the online reputation at operation 730. Attributes of the digital assets such a type of the digital asset may be matched to attributes of the suggested actions such as operations to modify a type of the digital asset. At operation 740, a report on the digital assets, the reputation profile, and the suggested actions may be transmitted to the reputation manager to prompt the reputation manager to customize the reputation profile and the suggested actions to shape the online reputation. At optional operation 750, the suggested actions to shape the online reputation of the reputation owner may be executed in response to a confirmation of the digital assets, the reputation profile, and the suggested actions by the reputation manager.

Some or all of the operations of the process 700 may be reprocessed with feedback operations. In an example scenario, the suggested actions matched in the operation 730 may be used as an input in the operation 720 to discover related digital assets. The related digital assets may be associated with the reputation owner. Other feedback loops may be used with other operations of the process 700 to customize operations of the process 700, among other things.

The operations included in process 700 are for illustration purposes. A reputation management service according to embodiments may be implemented by similar processes with fewer or additional steps, as well as in different order of operations using the principles described herein.

According to some examples a computing device to sign-up and provisioning in online reputation management with reputation shaping may be described. The computing device may include a memory configured to store instructions associated with a management service and one or more processors coupled to the memory. The one or more processors may execute the management service in conjunction with instructions stored in the memory. The management service may include a monitoring engine configured to discover digital assets associated with a reputation owner, where the digital assets are hosted by external resources. The management service may also include a policy engine configured to authenticate a reputation manager to allow the reputation manager to configure a reputation profile to shape the online reputation associated with the reputation owner, where the discovered digital assets form the reputation profile, analyze the digital assets and the reputation profile to match suggested actions with operations to shape the online reputation, and transmit a report on the digital assets, the reputation profile, and the suggested actions to the reputation manager to prompt the reputation manager to customize the reputation profile and the suggested actions to shape the online reputation.

According to other examples, the reputation manager may include one or more of the reputation owner, a legal representative of the reputation owner, an authorized family member of the reputation owner, an authorized relation of the reputation owner, an authorized colleague of the reputation owner, and an authorized supervisor of the reputation owner. The policy engine may be further configured to identify the reputation manager as a legal representative of the reputation owner and request a legal documentation from the reputation manager to prove a legal relationship. The policy engine may be further configured to receive the legal documentation and authenticate the reputation manager to allow a configuration of the reputation profile. The policy engine may be further configured to detect a failure to provide the legal documentation by the reputation owner within a period of time and decline to authenticate the reputation manager to prevent a configuration of the reputation profile.

According to further examples, the policy engine may be further configured to access one or more accounts of the reputation owner at the external resources with credentials of the reputation owner, where the credentials are identified in the reputation profile, search the one or more accounts of the reputation owner to locate the digital assets of the reputation owner, process the digital assets and one or more reputation goals defined in the reputation profile to match the digital assets to a subset of default reputation shaping actions, and select the subset of the default reputation shaping actions as the suggested actions.

According to other examples, the policy engine may be further configured to detect an identification information associated with the reputation owner within the reputation profile, search the external resources using the identification information for third party content that includes content associated with the reputation owner, process the third party content and one or more reputation goals defined in the reputation profile to match the content associated with the reputation owner within the third party content to a subset of default shaping actions, select another subset of the default shaping actions associated with the content associated with the reputation owner within the third party content as the suggested actions, and identify the content associated with the reputation owner within the third party content as part of the digital assets. The other subset of the default shaping actions associated with the content associated with the reputation owner within the third party content may include a disassociation request to transmit to the external resources and, where the disassociation request includes instructions to disassociate the identification information that identifies the reputation owner in the third party content. The policy engine may be further configured to execute the suggested actions to shape the online reputation of the reputation owner, in response to a confirmation of the digital assets, the reputation profile, and the suggested actions by the reputation manager.

According to some examples, a method executed on a computing device to provide sign-up and provisioning in online reputation management with reputation shaping may be described. The method may include authenticating a reputation manager to allow the reputation manager to configure a reputation profile to shape the online reputation associated with a reputation owner, discovering digital assets associated with the reputation owner, where the digital assets are hosted by external resources and the discovered digital assets form the reputation profile, analyzing the digital assets and the reputation profile to match suggested actions with operations to shape the online reputation, transmitting a report on the digital assets, the reputation profile, and the suggested actions to the reputation manager to prompt the reputation manager to customize the reputation profile and the suggested actions to shape the online reputation, and executing the suggested actions to shape the online reputation of the reputation owner, in response to a confirmation of the digital assets, the reputation profile, and the suggested actions by the reputation manager.

According to other examples, the method may further include authenticating the reputation manager with a biometric scheme to confirm an identity of the reputation manager. The method may further include authenticating the reputation manager with a heuristic scheme to confirm an identity of the reputation manager, where the heuristic scheme verifies the identity of the reputation manager based on one or more of a recent activity and a past action on the digital assets as performed by the reputation owner. The method may further include classifying the digital assets into one or more asset categories and matching the digital assets and the reputation profile to the suggested actions based on the one or more asset categories, where the suggested actions are partitioned based on the one or more asset categories. The one or more asset categories may include one or more of a private classification, a work-related classification, a sensitive classification, a secret classification, a time of creation based classification, a location of creation based classification, a creator based classification, and a modifier based classification. The one or more asset categories may include one or more of a picture classification, a document classification, a music classification, a video classification, a purchased subscription classification, a social networking account association, and a professional networking account association.

According to some examples, a computer-readable memory device with instructions stored thereon to provide sign-up and provisioning in online reputation management with reputation shaping may be described. The instructions may include actions that are similar to the method described above.

According to some examples a means to provide sign-up and provisioning in online reputation management with reputation shaping may be described. The means to provide sign-up and provisioning in online reputation management with reputation shaping may include a means to discover digital assets associated with a reputation owner, where the digital assets are hosted by external resources, a means to authenticate a reputation manager to allow the reputation manager to configure a reputation profile to shape the online reputation associated with the reputation owner, where the discovered digital assets form the reputation profile, a means to analyze the digital assets and the reputation profile to match suggested actions with operations to shape the online reputation, and a means to transmit a report on the digital assets, the reputation profile, and the suggested actions to the reputation manager to prompt the reputation manager to customize the reputation profile and the suggested actions to shape the online reputation.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide reputation shaping to provide sign-up and provisioning in online reputation management with reputation shaping, the computing device comprising:
a memory configured to store instructions associated with a reputation management service;
one or more processors coupled to the memory, the one or more processors executing the management service in conjunction with the instructions stored in the memory, wherein the reputation management service includes:
a monitoring engine configured to:
discover digital assets associated with a reputation owner, wherein the digital assets are hosted by external resources;
a policy engine configured to:
authenticate a reputation manager to allow the reputation manager to configure a reputation profile to shape the online reputation associated with the reputation owner, wherein the discovered digital assets form the reputation profile;
analyze the digital assets and the reputation profile to match suggested actions with operations to shape the online reputation; and
transmit a report on the digital assets, the reputation profile, and the suggested actions to the reputation manager to prompt the reputation manager to customize the reputation profile and the suggested actions to shape the online reputation.

2. The computing device of claim 1, wherein the reputation manager includes one or more of the reputation owner, a legal representative of the reputation owner, an authorized family member of the reputation owner, an authorized relation of the reputation owner, an authorized colleague of the reputation owner, and an authorized supervisor of the reputation owner.

3. The computing device of claim 1, wherein the policy engine is further configured to:
identify the reputation manager as a legal representative of the reputation owner; and
request a legal documentation from the reputation manager to prove a legal relationship.

4. The computing device of claim 3, wherein the policy engine is further configured to:
receive the legal documentation; and
authenticate the reputation manager to allow a configuration of the reputation profile.

5. The computing device of claim 3, wherein the policy engine is further configured to:
detect a failure to provide the legal documentation by the reputation owner within a period of time; and
decline to authenticate the reputation manager to prevent a configuration of the reputation profile.

6. The computing device of claim 1, wherein the policy engine is further configured to:
access one or more accounts of the reputation owner at the external resources with credentials of the reputation owner, wherein the credentials are identified in the reputation profile; and
search the one or more accounts of the reputation owner to locate the digital assets of the reputation owner.

7. The computing device of claim 6, wherein the policy engine is further configured to:
process the digital assets and one or more reputation goals defined in the reputation profile to match the digital assets to a subset of default reputation shaping actions; and
select the subset of the default reputation shaping actions as the suggested actions.

8. The computing device of claim 1, wherein the policy engine is further configured to:
detect an identification information associated with the reputation owner within the reputation profile; and
search the external resources using the identification information for third party content that includes content associated with the reputation owner.

9. The computing device of claim 8, wherein the policy engine is further configured to:
process the third party content and one or more reputation goals defined in the reputation profile to match the content associated with the reputation owner within the third party content to a subset of default shaping actions;
select another subset of the default shaping actions associated with the content associated with the reputation owner within the third party content as the suggested actions; and
identify the content associated with the reputation owner within the third party content as part of the digital assets.

10. The computing device of claim 9, wherein the other subset of the default shaping actions associated with the content associated with the reputation owner within the third party content include a disassociation request to transmit to the external resources and, wherein the disassociation request includes instructions to disassociate the identification information that identifies the reputation owner in the third party content.

11. The computing device of claim 1, wherein the policy engine is further configured to:
execute the suggested actions to shape the online reputation of the reputation owner, in response to a confirmation of the digital assets, the reputation profile, and the suggested actions by the reputation manager.

12. A method executed on a computing device to provide sign-up and provisioning in online reputation management with reputation shaping, the method comprising:
authenticating a reputation manager to allow the reputation manager to configure a reputation profile to shape the online reputation associated with a reputation owner;
discovering digital assets associated with the reputation owner, wherein the digital assets are hosted by external resources and the discovered digital assets form the reputation profile;
analyzing the digital assets and the reputation profile to match suggested actions with operations to shape the online reputation;
transmitting a report on the digital assets, the reputation profile, and the suggested actions to the reputation manager to prompt the reputation manager to customize the reputation profile and the suggested actions to shape the online reputation; and
executing the suggested actions to shape the online reputation of the reputation owner, in response to a confirmation of the digital assets, the reputation profile, and the suggested actions by the reputation manager.

13. The method of claim 12, further comprising:
authenticating the reputation manager with a biometric scheme to confirm an identity of the reputation manager.

14. The method of claim 12, further comprising:
authenticating the reputation manager with a heuristic scheme to confirm an identity of the reputation manager, wherein the heuristic scheme verifies the identity of the reputation manager based on one or more of a recent activity and a past action on the digital assets as performed by the reputation owner.

15. The method of claim 12, further comprising:
classifying the digital assets into one or more asset categories; and
matching the digital assets and the reputation profile to the suggested actions based on the one or more asset categories, wherein the suggested actions are partitioned based on the one or more asset categories.

16. The method of claim 15, wherein the one or more asset categories include one or more of a private classification, a work-related classification, a sensitive classification, a secret classification, a time of creation based classification, a location of creation based classification, a creator based classification, and a modifier based classification.

17. The method of claim 15, wherein the one or more asset categories include one or more of a picture classification, a document classification, a music classification, a video classification, a purchased subscription classification, a social networking account association, and a professional networking account association.

18. A computer-readable memory device with instructions stored thereon to provide sign-up and provisioning in online reputation management with reputation shaping, the instructions comprising:
authenticating a reputation manager to allow the reputation manager to configure a reputation profile to shape the online reputation associated with a reputation owner, wherein the reputation manager includes one or more of the reputation owner, a legal representative of the reputation owner, an authorized family member of the reputation owner, an authorized relation of the reputation owner, an authorized colleague of the reputation owner, and an authorized supervisor of the reputation owner;
discovering digital assets associated with the reputation owner, wherein the digital assets are hosted by external resources and the discovered digital assets form the reputation profile;
analyzing the digital assets and the reputation profile to match suggested actions with operations to shape the online reputation;
transmitting the digital assets, the reputation profile, and the suggested actions to the reputation manager to prompt the reputation manager to customize the reputation profile and the suggested actions to shape the online reputation; and
executing the suggested actions to shape the online reputation of the reputation owner, in response to a confirmation of the digital assets, the reputation profile, and the suggested actions by the reputation manager.

19. The computer-readable memory device of claim 18, wherein the instructions further comprise:
accessing one or more accounts of the reputation owner at the external resources using credentials of the reputation owner, wherein the credentials are identified in the reputation profile;
searching the one or more accounts of the reputation owner to locate the digital assets of the reputation owner;
processing the digital assets and one or more reputation goals defined in the reputation profile to match the digital assets to a subset of default reputation shaping actions; and
selecting the subset of the default reputation shaping actions as the suggested actions.

20. The computer-readable memory device of claim 18, wherein the instructions further comprise:
classifying the digital assets into one or more asset categories, wherein the one or more asset categories include one or more of a picture classification, a document classification, a music classification, a video classification, a purchased subscription classification, a social networking account association, and a professional networking account association; and
matching the digital assets and the reputation profile to the suggested actions based on the one or more asset categories, wherein the suggested actions are partitioned based on the one or more asset categories.
